(19) United States
(12) Patent Application Publication
(10) Pub. No.: US 2009/0271234 A1
(43) Pub. Date: Oct. 29, 2009

(54) EXTRACTION AND MODELING OF IMPLEMENTED BUSINESS PROCESSES

(76) Inventors: John Hack, Maplewood, NJ (US); Hak Woo Kim, Stamford, CT (US); Christian Gheorghe, Wilton, CT (US)

Correspondence Address: SAP AG c/o BUCKLEY, MASCHOFF & TALWALKAR LLC, 50 LOCUST AVENUE, NEW CANAAN, CT, 06840, US

(21) Appl. No.: 12/241,886

(22) Filed: Sep. 30, 2008

Related U.S. Application Data
(60) Provisional application No. 61/047,145, filed on Apr. 23, 2008.

(51) Int. Cl. G06Q 10/00

(52) U.S. Cl. 705/7

(57) ABSTRACT

A system and method in which an implemented business process to model is identified, and one or more markup language files are automatically generated specifying metadata and a structure of the business process.

### CROSS REFERENCE TO RELATED APPLICATIONS

This application claims priority to U.S. Provisional Patent Application Ser. No. 61/047,145, filed Apr. 23, 2008 and entitled “SYSTEMS TO PROVIDE BUSINESS APPLICATION MARKETPLACE”, the contents of which are incorporated by reference herein for all purposes.

This application is related to commonly-assigned U.S. patent application Ser. No. (attorney docket no. 2008P00119US), filed on even date herewith and entitled “SYSTEMS TO IMPLEMENT BUSINESS PROCESSES IN COMPUTING ENVIRONMENT”.

### BACKGROUND

Business software is typically delivered to a customer and then tailored within the customer's computing environment to the customer's existing systems and workflows. The software may implement particular business processes and may allow the customer (or a consultant under the direction of the customer) to change the implemented business processes and/or to implement new business processes.

The above-described business process implementations are specific to the customer's particular computing platform, such as the SAP NetWeavem™ platform or the Microsoft .NET platform, and also to the underlying data schema (e.g., star, snowflake, etc.). Conventional systems provide no mechanism for efficiently porting the underlying business processes to a different computing platform and/or data schema. Primarily, conventional systems offer no facility for determining a comprehensive, useful and implementation-independent description of an already-implemented business process.

Systems are desired for efficiently extracting and modeling implemented business processes.

### BRIEF DESCRIPTION OF THE DRAWINGS

FIG. 1 is a block diagram of a system according to some embodiments.

FIG. 2 is a flow diagram of a process according to some embodiments.

FIG. 3 is a block diagram of a system according to some embodiments.

FIG. 4 is a flow diagram of a process according to some embodiments.

FIG. 5 is an outward view of a user interface according to some embodiments.

FIG. 6 is an outward view of a user interface according to some embodiments.

FIG. 7 is a representative view of a folder/file structure according to some embodiments.

### DETAILED DESCRIPTION

The following description is provided to enable any person in the art to make and use the described embodiments and sets forth the best mode contemplated by the inventors for carrying out some embodiments. Various modifications, however, will remain readily apparent to those in the art.

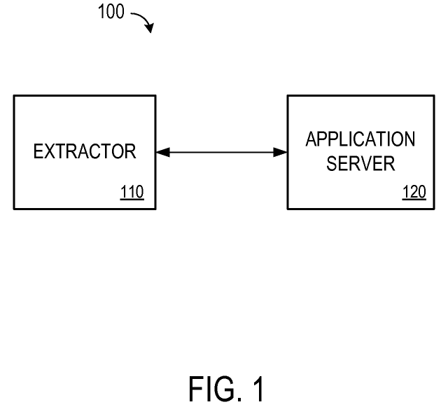

FIG. 1 is a block diagram of system 100 according to some embodiments. System 100 comprises extractor 110 and application server 120. The elements of system 100 may be implemented using any combinations of hardware and/or software that are or become known. According to some embodiments, system 100 includes elements in addition to those illustrated in FIG. 1.

Extractor 110 may comprise executable program code embodying one or more of the processes to be described herein, and/or computer hardware for executing such program code. Extractor 110 may be embodied in a standalone executable file (e.g., an .exe file) or in code (e.g., a JAVA applet) executable by a virtual machine. Application server 120 may also comprise hardware and/or software. Details of application server 120 according to some embodiments are set forth below.

Application server 120 includes information relating to business processes. A business process may comprise pre-implemented software functionality for a target business segment. A business process may include, but is not limited to, functionality related to schedules, reports, ETL processes, management approvals, standard business practices (e.g., revenue forecasts by product line, costs by department), and security. Business processes may guide and coordinate end users toward a common performance management goal such as creating a compliant forecast or statutory-consolidated financial results. Embodiments may comprise any types of business applications, Web Services, and software-provided functions that are or becomes known.

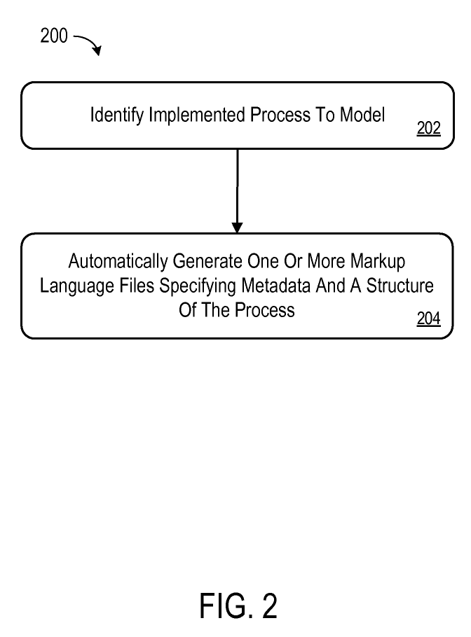

FIG. 2 is a flow diagram of process 200 according to some embodiments. Process 200 may be executed by hardware and embodied in program code stored on a tangible computer-readable medium. System 100 may execute process 200, but embodiments are not limited thereto.

Initially, at 202, an implemented process to model is identified. An implemented process may comprise a business process or any other process that is capable of functioning in a particular computing environment. For example, a process may exist in the form of program code residing on application server 120. The program code may implement one or more Web Services, process agents, reports, queries, data structures, and/or any other software constructs. The program code may be compatible with an enterprise platform (e.g., SAP NetWeaver™) and may access persisted data structured according to a particular schema (e.g., star schema).

According to some embodiments of 202, extractor 110 of system 100 queries application server 120 for a list of processes available for modeling. The list is presented to a user, who selects a listed process via a user interface of extractor 110. Extractor 110 may then provide an indication of the selected process to application server 120.

Next, one or more markup language files is automatically generated at 204. The markup language files specify metadata and a structure of the selected process. In some embodiments, the markup language files may describe the selected process in a manner allowing the selected process to be implemented in a computing environment that is different from the environment in which it is implemented.

Application server 120 may generate the markup language files at 204 and provide the files to extractor 110. Extractor 110 may then compress the one or more files (e.g., create a .zip file) for local storage. In some embodiments, application server 120 provides the metadata, steps and associated objects to extractor 110 and extractor 110 generates the one or more markup language files based thereon. As will be described in detail below, the one or more markup language files may be structured in a hierarchical folder structure to facilitate understanding thereof.

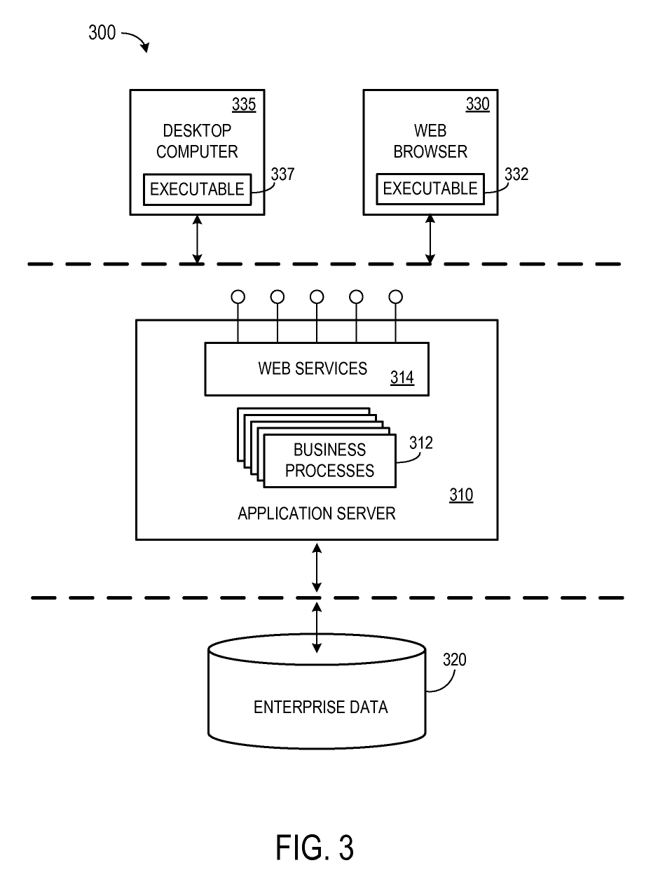

FIG. 3 is a block diagram of a computing architecture according to some embodiments. Architecture 300 generally represents a client-server architecture as is known in the art. Architecture 300 may implement system 100 and/or process 200 described above.

Application server 310 may provide functionality to client devices. For example, application server 310 may access raw data of enterprise data 320 in response to user queries. Application server 310 may also provide business context and logic to assist with the interpretation of the raw data. In this regard, application server 310 may encapsulate the raw data into business objects including both data and related logic.

Application server 310 may provide for the execution of business processes 312. Business processes 312 may comprise any business processes including, but not limited to, those described above. One or more of business processes 312 may be implemented as a Web Service and exposed via Web Services 314. Web Services 314 may also include services for extracting metadata, steps, and associated objects of one or more of business processes 312.

Web browser 330 may reside on any suitable device, such as a desktop computer, a laptop computer, a personal digital assistant, a tablet PC, and a smartphone. Web Browser 330 may execute applet 332 to call one or more of Web Services 314 and to thereby retrieve information and/or markup language files from application server 310 according to some embodiments. Similarly, desktop computer 335 may execute executable file 337 to access one or more of Web Services 314.

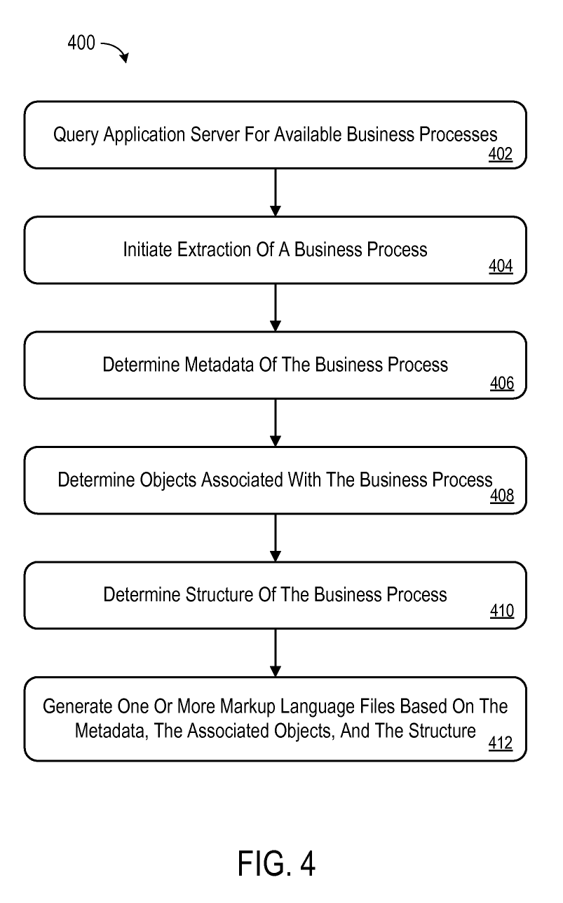

FIG. 4 is a flow diagram of process 400 according to some embodiments. Process 400 may be executed by hardware and embodied in program code stored on a tangible medium. Process 400 may comprise an embodiment of process 200 of FIG. 2. System 100 or system 300 may execute process 400, but embodiments are not limited thereto.

The elements of process 400 will be described with respect to a particular example. Embodiments may differ in part or in whole from the example.

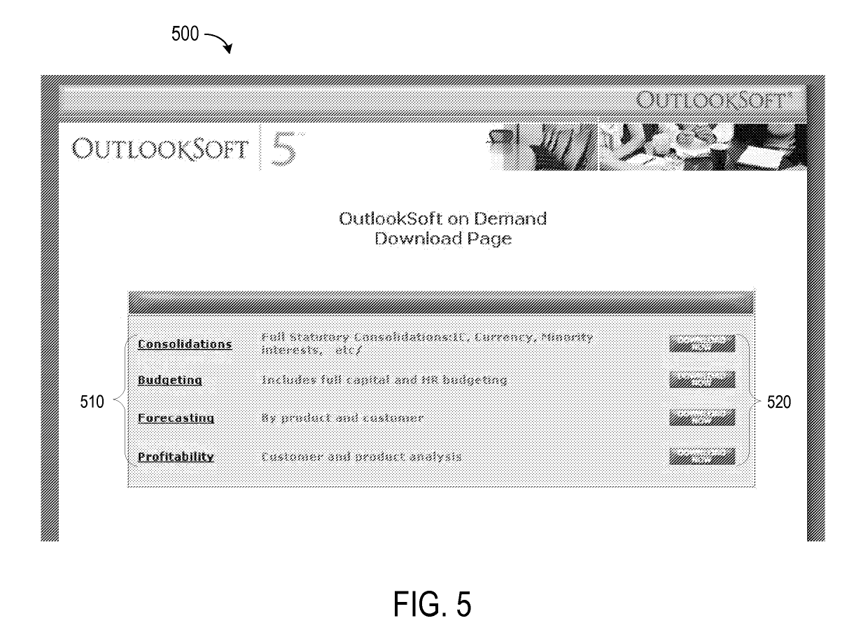

Initially, at 402, an application server is queried for available business processes. For example, a user may operate Web browser 330 to request a Web page served by application server 310. FIG. 5 is an outward view of Web page 500 that may be displayed to a user in some embodiments of 402.

Web page 500 lists collections 510 of business processes 312 which are available for extraction from application server 310. Each of collections 510 may include one or more of business processes 312, and two or more collections 510 may include a same business process 312. The business processes 312 of a collection 510 may bear a logical relation to one another according to some embodiments. The user may select one of collections 510 by selecting a corresponding one of Download icons 520, and may thereby initiate extraction of the corresponding business process(es) at 404.

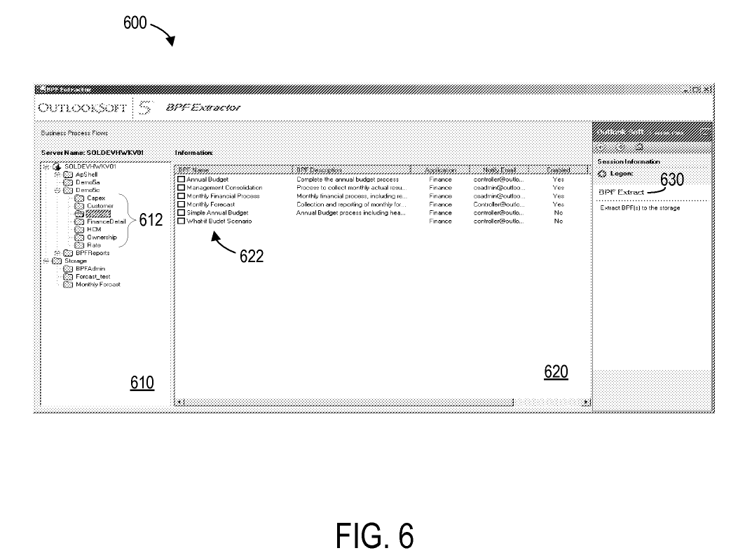

FIG. 6 illustrates an alternative user interface according to some embodiments. Window 600 may be displayed by desktop computer 335 in response to execution of executable 337. More particularly, desktop computer 335 may invoke one of Web Services 314 at 402 to retrieve a list of available business processes (or business process collections), and may display the list within window 600.

Left pane 610 illustrates applications 612 (e.g., Online Analytical Processing (OLAP) cubes) supported by application server 310. Middle pane 620 displays collections 622 associated with a selected one of applications 612. The user may select one or more of collections 622 via corresponding checkboxes and may select BPF Extract link 630 to initiate extraction of the associated business process(es) at 404.

According to some embodiments, 404 comprises invoking of one or more of Web Services 314 to request information related to a business process. As a result of this invocation, metadata of the selected business process is determined at 406. This metadata may include a name of the business process, a description of the business process, and information regarding the controlling application (e.g., an OLAP cube).

One or more of Web Services 314 may also be invoked to determine objects associated with the business process at 408. These objects may include report templates, ETL processes, Uniform Resource Locators, or the like. In some embodiments where the report templates are Microsoft Office 2007 documents, the report templates may be formatted according to an open eXtensible Markup language (XML) format for defining spreadsheets. ETL processes may be similarly formatted, particularly if the environment of application server 310 is Microsoft SQL 2005. Also determined at 408 may be business logic associated with the business process.

A structure of the business process is determined at 410. The structure may specify data structures needed to support actions of the business process. The structure may also or alternatively specify details of the data dimensions utilized during the business process. In some embodiments, supplemental files are also received during process 400. The supplemental files may include user documentation (e.g., Readme files), or general member table.

At 412, one or more markup language files is generated based on the metadata, the objects, and the structure associated with the business process. The markup language files may be formatted according to any suitable markup language schema. A detailed example of one such schema is set forth below.

Functions 406 through 412 may be performed by one or both of Web Services 314 and a client-side element such as executable 337. For example, Web Services 314 may execute 406 through 412 and transmit one or more markup language files to executable 337. In this regard, Web Services 314 may be capable of generating the markup language files because Web Services 314 are aware of how the determined elements of the business process are represented in the platform (e.g., application server 310) and are also aware of the markup language schema. Executable 337 may then create a folder structure such as below-described folder structure 700 based on the markup language files. In some embodiments, Web Services 314 perform the determinations at 406 through 410 and transmits results of the determinations to executable 337, which in turn generates the one or more markup language files at 412.

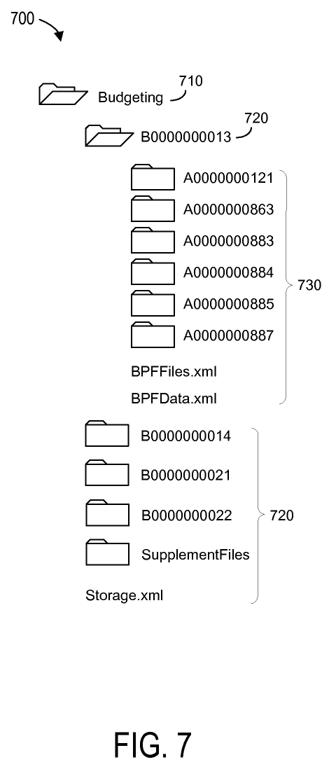

FIG. 7 illustrates folder structure 700 that may result from operation of some embodiments. Folder structure 700 may reside locally on desktop computer 335 after execution of process 400 according to some embodiments.

Folder structure 700 includes top level 710, which includes folders dedicated to specific collections of business processes. Folder structure 710 includes one such collection, entitled Budgeting, but embodiments are not limited thereto. Level 720 includes folders relating to specific business processes. For example, execution of process 400 may result in the generation of one of the folders of level 720.

Level 720 also includes markup language file Storage.xml, which includes information relating to the collection of level 710. An example of Storage.xml of folder structure 700 and according to some embodiments is set forth below. As shown, Storage.xml may include a name of the associated collection, a short description of the collection, and a long description of the collection. Storage.xml also includes nested information relating to each business process in the collection. For each business process in the collection, Storage.xml specifies, among other information, an id, a name, a description, a controlling application (e.g., OLAP cube), and a folder in which further details of the business process are described.

```
<storage>
  <name><![CDATA[Budgeting]]></name>
  <shortdesc><![CDATA[Annual Budgeting process for Capital, HR,
Revenue and Expenses.]]></shortdesc>
  <longdesc><![CDATA[Annual budgeting process that includes Capital,
HR, Revenue and Expenses. The reporting provides Income Statement,
Balance Sheet and Cash Flow.]]></longdesc>
  <bpf>
    <bpfpackageid><![CDATA[B00000000022]]></bpfpackageid>
    <bpfid><![CDATA[B00000000022]]></bpfid>
    <bpfname><![CDATA[BS & Cash Flow]]></bpfname>
    <bpfdesc><![CDATA[Plan Balance Sheet & Cash Flow using
drivers & rollforwards]]></bpfdesc>
    <application><![CDATA[Finance]]></application>
    <servername><![CDATA[DEMO5]]></servername>
    <storeddate><![CDATA[20070419110445]]></storeddate>
    <appset><![CDATA[Demo5a]]></appset>
    <foldername><![CDATA[B00000000022_1]]></foldername>
    <seq><![CDATA[1]]></seq>
    <outlooksoftversion><![CDATA[5.0.454]]></outlooksoftversion>
    <extractorversion><![CDATA[5.0.0.003]]></extractorversion>
    <applicationtype><![CDATA[5]]></applicationtype>
    <FXTrans><![CDATA[1]]></FXTrans>
    <InterCompany><![CDATA[0]]></InterCompany>
    <Calculation><![CDATA[1]]></Calculation>
    <IntcoBookings><![CDATA[0]]></IntcoBookings>
    <USElim><![CDATA[1]]></USElim>
    <OpeningBalance><![CDATA[0]]></OpeningBalance>
    <Validations><![CDATA[0]]></Validations>
  </bpf>
  <bpf>
    <bpfpackageid><![CDATA[B00000000014]]></bpfpackageid>
    <bpfid><![CDATA[B00000000014]]></bpfid>
    <bpfname><![CDATA[Capital Expenditures]]></bpfname>
    <bpfdesc><![CDATA[Plan new asset acquisitions and associated
depreciation.]]></bpfdesc>
    <application><![CDATA[Capex]]></application>
    <servername><![CDATA[DEMO5]]></servername>
    <storeddate><![CDATA[20070419110447]]></storeddate>
    <appset><![CDATA[Demo5a]]></appset>
    <foldername><![CDATA[B00000000014_2]]></foldername>
    <seq><![CDATA[2]]></seq>
    <outlooksoftversion><![CDATA[5.0.454]]></outlooksoftversion>
    <extractorversion><![CDATA[5.0.0.003]]></extractorversion>
    <applicationtype><![CDATA[5]]></applicationtype>
    <FXTrans><![CDATA[1]]></FXTrans>
    <InterCompany><![CDATA[0]]></InterCompany>
    <Calculation><![CDATA[0]]></Calculation>
    <IntcoBookings><![CDATA[0]]></IntcoBookings>
    <USElim><![CDATA[0]]></USElim>
    <OpeningBalance><![CDATA[0]]></OpeningBalance>
    <Validations><![CDATA[0]]></Validations>
  </bpf>
  <bpf>
    <bpfpackageid><![CDATA[B00000000013]]></bpfpackageid>
    <bpfid><![CDATA[B00000000013]]></bpfid>
    <bpfname><![CDATA[HR Planning]]></bpfname>
    <bpfdesc><![CDATA[Plan headcount, salaries, and related
expenses]]></bpfdesc>
    <application><![CDATA[HCM]]></application>
    <servername><![CDATA[DEMO5]]></servername>
    <storeddate><![CDATA[20070419110449]]></storeddate>
    <appset><![CDATA[Demo5a]]></appset>
    <foldername><![CDATA[B00000000013_3]]></foldername>
    <seq><![CDATA[3]]></seq>
    <outlooksoftversion><![CDATA[5.0.454]]></outlooksoftversion>
    <extractorversion><![CDATA[5.0.0.003]]></extractorversion>
    <applicationtype><![CDATA[5]]></applicationtype>
    <FXTrans><![CDATA[1]]></FXTrans>
    <InterCompany><![CDATA[0]]></InterCompany>
    <Calculation><![CDATA[1]]></Calculation>
    <IntcoBookings><![CDATA[0]]></IntcoBookings>
    <USElim><![CDATA[0]]></USElim>
    <OpeningBalance><![CDATA[0]]></OpeningBalance>
    <Validations><![CDATA[0]]></Validations>
  </bpf>
  <bpf>
    <bpfpackageid><![CDATA[B00000000021]]></bpfpackageid>
    <bpfid><![CDATA[B00000000021]]></bpfid>
    <bpfname><![CDATA[Revenue & Expenses]]></bpfname>
    <bpfdesc><![CDATA[Plan revenue & expenses]]></bpfdesc>
    <application><![CDATA[Finance]]></application>
    <servername><![CDATA[DEMO5]]></servername>
    <storeddate><![CDATA[20070419110450]]></storeddate>
    <appset><![CDATA[Demo5a]]></appset>
    <foldername><![CDATA[B00000000021_4]]></foldername>
    <seq><![CDATA[4]]></seq>
    <outlooksoftversion><![CDATA[5.0.454]]></outlooksoftversion>
    <extractorversion><![CDATA[5.0.0.003]]></extractorversion>
    <applicationtype><![CDATA[5]]></applicationtype>
    <FXTrans><![CDATA[1]]></FXTrans>
    <InterCompany><![CDATA[0]]></InterCompany>
    <Calculation><![CDATA[1]]></Calculation>
    <IntcoBookings><![CDATA[0]]></IntcoBookings>
    <USElim><![CDATA[1]]></USElim>
    <OpeningBalance><![CDATA[0]]></OpeningBalance>
    <Validations><![CDATA[0]]></Validations>
  </bpf>
</storage>
```

Each folder of level 720 corresponds to a single business process. Each subfolder thereof (i.e., at level 730) includes an object (if any) associated with an action of the business process. Such objects may include spreadsheet templates, ETL information, or other objects in a native or markup language format. Each folder of level 720 also includes markup language files entitled BPFFiles.xml and BPFData.xml.

An example of BPFFiles.xml of FIG. 7 and according to some embodiments is provided below. The example provides details of actions associated with the business process represented by the folder containing the BPFFiles.xml file. Specifically, the file specifies an identifier of the action, an object associated with the action (e.g., a .xlt file), and other associated information. Moreover, each identifier corresponds to a folder of level 730.

```
<bpffiles>
  <bpffile>
    <BPFID><![CDATA[B00000000013]]></BPFID>
    <ActionName><![CDATA[Promotion & Transfer
    Approvals]]></ActionName>
    <ActionID><![CDATA[A00000000883]]></ActionID>
    <ActionTaskID><![CDATA[T0031]]></ActionTaskID>
    <File><![CDATA[S03-Approvals.xlt]]></File>
    <FileMapSubTask><![CDATA[OpenScheduleLibrary]]>
    </FileMapSubTask>
    <FileMapTask><![CDATA[WebExcel]]></FileMapTask>
    <SubFolder><![CDATA[Budget/]]></SubFolder>
    <Team><![CDATA[ ]]></Team>
    <Exist><![CDATA[Y]]></Exist>
  </bpffile>
  <bpffile>
    <BPFID><![CDATA[B00000000013]]></BPFID>
    <ActionName><![CDATA[Salary Increase
    Exceptions]]></ActionName>
    <ActionID><![CDATA[A00000000887]]></ActionID>
    <ActionTaskID><![CDATA[T0030]]></ActionTaskID>
    <File><![CDATA[B04-Salary Increase Exceptions.xlt]]></File>
    <FileMapSubTask><![CDATA[OpenReportLibrary]]>
    </FileMapSubTask>
    <FileMapTask><![CDATA[WebExcel]]></FileMapTask>
    <SubFolder><![CDATA[Budget/]]></SubFolder>
    <Team><![CDATA[ ]]></Team>
    <Exist><![CDATA[Y]]></Exist>
  </bpffile>
  <bpffile>
    <BPFID><![CDATA[B00000000013]]></BPFID>
    <ActionName><![CDATA[New Hires]]></ActionName>
    <ActionID><![CDATA[A00000000885]]></ActionID>
    <ActionTaskID><![CDATA[T0030]]></ActionTaskID>
    <File><![CDATA[B03-NewHires.xlt]]></File>
    <FileMapSubTask><![CDATA[OpenReportLibrary]]>
    </FileMapSubTask>
    <FileMapTask><![CDATA[WebExcel]]></FileMapTask>
    <SubFolder><![CDATA[Budget/]]></SubFolder>
    <Team><![CDATA[ ]]></Team>
    <Exist><![CDATA[Y]]></Exist>
  </bpffile>
  <bpffile>
    <BPFID><![CDATA[B00000000013]]></BPFID>
    <ActionName><![CDATA[Total Personnel
    Expenses]]></ActionName>
    <ActionID><![CDATA[A00000000863]]></ActionID>
    <ActionTaskID><![CDATA[T0030]]></ActionTaskID>
    <File><![CDATA[B02-Personnel Expenses.xlt]]></File>
    <FileMapSubTask><![CDATA[OpenReportLibrary]]>
    </FileMapSubTask>
    <FileMapTask><![CDATA[WebExcel]]></FileMapTask>
    <SubFolder><![CDATA[Budget/]]></SubFolder>
    <Team><![CDATA[ ]]></Team>
    <Exist><![CDATA[Y]]></Exist>
  </bpffile>
  <bpffile>
    <BPFID><![CDATA[B00000000013]]></BPFID>
    <ActionName><![CDATA[Employee
    Trend]]></ActionName>
    <ActionID><![CDATA[A00000000884]]></ActionID>
    <ActionTaskID><![CDATA[T0030]]></ActionTaskID>
    <File><![CDATA[B01-Employee Trend.xlt]]></File>
    <FileMapSubTask><![CDATA[OpenReportLibrary]]>
    </FileMapSubTask>
    <FileMapTask><![CDATA[WebExcel]]></FileMapTask>
    <SubFolder><![CDATA[Budget/]]></SubFolder>
    <Team><![CDATA[ ]]></Team>
    <Exist><![CDATA[Y]]></Exist>
  </bpffile>
  <bpffile>
    <BPFID><![CDATA[B00000000013]]></BPFID>
    <ActionName><![CDATA[Salary
    Planning]]></ActionName>
    <ActionID><![CDATA[A00000000121]]></ActionID>
    <ActionTaskID><![CDATA[T0031]]></ActionTaskID>
    <File><![CDATA[S02-SalaryPlanning.xlt]]></File>
    <FileMapSubTask><![CDATA[OpenScheduleLibrary]]>
    </FileMapSubTask>
    <FileMapTask><![CDATA[WebExcel]]></FileMapTask>
    <SubFolder><![CDATA[Budget/]]></SubFolder>
    <Team><![CDATA[ ]]></Team>
    <Exist><![CDATA[Y]]></Exist>
  </bpffile>
</bpffiles>
```

The BPFData.xml file, according to the present example, specifies the structure of the business process with which it is associated in folder structure 700. The structure of the business process may include data structures needed to support actions of the business process, details of the data dimensions utilized during the business process, and details of steps, sub steps and actions. An example BPFData.xml file is listed below.

What is claimed is:

1. A method comprising:
identifying an implemented business process to model; and
automatically generating one or more markup language files specifying metadata and a structure of the business process.

2. A method according to claim 1, further comprising:
determining the structure of the business process.

3. A method according to claim 2, wherein determining the structure of the business process comprises:
determining data structures for supporting actions of the business process; and
determining dimension information associated with the business process.

4. A method according to claim 1, further comprising:
receiving supplemental files associated with the business process.

5. A method according to claim 4, wherein the supplemental files comprise user documentation.

6. A method according to claim 1, wherein automatically generating the one or more markup language files comprises:
automatically generating one or more markup language files specifying metadata, the structure and objects associated with the business process.

7. A method according to claim 6, wherein the objects comprise report templates.

8. A method according to claim 7, wherein the objects comprise business logic and ETL tools.

9. A computer-readable medium having stored thereon program code, the program code executable by a computer to:
identify an implemented business process to model; and
automatically generate one or more markup language files specifying metadata and a structure of the business process.

10. A medium according to claim 9, the program code further executable by a computer to:
determine the structure of the business process.

11. A medium according to claim 10, wherein determination of the structure of the business process comprises:
determination of data structures for supporting actions of the business process; and
determination of dimension information associated with the business process.

12. A medium according to claim 9, the program code further executable by a computer to:
receive supplemental files associated with the business process.

13. A medium according to claim 12, wherein the supplemental files comprise user documentation.

14. A medium according to claim 9, wherein automatically generation of the one or more markup language files comprises:
automatically generation of one or more markup language files specifying metadata, the structure and objects associated with the business process.

15. A medium according to claim 14, wherein the objects comprise report templates.

16. A medium according to claim 15, wherein the objects comprise business logic and ETL tools.
